(19) United States
(12) Patent Application Publication
(10) Pub. No.: US 2021/0177015 A1
(43) Pub. Date: Jun. 17, 2021

(54) HIGH FREQUENCY DEVICE FOR HEATING FOOD PRODUCT, AND ASSOCIATED SYSTEMS AND METHODS

(71) Applicant: John Bean Technologies Corporation, Chicago, IL (US)

(72) Inventor: Richard R. Brounley, Clearwater, FL (US)

(73) Assignee: John Bean Technologies Corporation, Chicago, IL (US)

(21) Appl. No.: 16/717,980

(22) Filed: Dec. 17, 2019

(51) Int. Cl. A23L 3/01; A23L 5/30; A23L 3/00; B65B 55/16

(52) U.S. Cl. CPC A23L 3/01; A23L 5/34; A23V 2300/24; B65B 55/16; A23V 2002/00; A23L 3/001

(57) ABSTRACT

In an embodiment, an apparatus for heat treatment of food product by radio frequency (RF) includes a transmission line having: a center conductor that includes a stack of food product packages, and an outer shield that at least partially encloses the center conductor. An RF connector is electrically coupled with the center conductor and with a source of RF voltage.

### BACKGROUND

Food products may be processed using different techniques depending on the type and quantity of food product, energy constraints, process controls, cost of processing, and the like. Elimination/reduction of the microorganisms from the food products is one of the goals of food processing. For example, processing of food products may include heating to a pasteurization temperature (usually less than 100° C.), which is a process that kills the pathogenic bacteria, or a sterilization temperature (usually 110-130° C.), which is a process of destruction of all microorganisms and their spores.

FIG. 1 is a block diagram of food product processing according to prior art. In the upper process flow of FIG. 1, the process starts with liquid food, which receives a pre-process such as pasteurization, followed by an ultra-high temperature process (usually 138-145° C.), which leaves the product sterile. When filled in a container under aseptic conditions and the container sealed under aseptic conditions, the food remains sterile throughout these food handling stages. Another possible approach is illustrated by the lower branch of FIG. 1. Here, the food product is sterilized (step 4) after being enclosed in a container that can be, for example, can, jar, box, or the like. Because the food product is hermetically enclosed in the container prior to sterilization, the food product remains sterile after the processing. Some examples of the food sterilization/pasteurization are described with reference to FIGS. 2-3B below.

FIG. 2 is a schematic drawing of steam heating of canned food product 15 according to prior art. In operation, the canned food product 15 is subjected to high temperature and high-pressure steam 12 (e.g., temperature of steam exceeding 120° C.). The steam heats up the can itself, and the food product is first heated through its periphery that contacts the can, and then heat transfers further toward the center of the food product. In some applications, the food product is rotated or shaken to improve the heat transfer rates, such that the center of the canned food product 15 reaches the target sterilization temperature faster. The temperature of the steam must be kept at a reasonably low level, as to not overheat the peripheral layers of the food product, which could degrade the quality of the food product. Depending on the size of the can, type of the food product, temperature of the steam and velocity of the steam, heating up of the canned food product generally takes minutes or tens of minutes. In many practical applications, such a duration of heating up makes the process expensive and/or too slow to meet certain food quality preservation standards.

FIG. 3A is a schematic drawing of liquid food cooking using radio frequency (RF) technology according to prior art. Here, liquid food product 22, which may be in a liquid or semi-liquid phase, flows out of a food hopper 21 through a food conduit (e.g., pipe) 24. The food product 22 may be pumped or gravity-fed. The pipe 24 is sandwiched by electrodes 26 along a length of the pipe. In operation, the electrodes 26 are energized by an RF source 28, thus subjecting the pipe 24 and the liquid food 22 to an electromagnetic field, which, in turn, heats up the liquid food. As the liquid food product 22 flows through the pipe 24, the food product heats up, and reaches its cooking temperature before being collected in the food container (e.g., can) 15.

FIG. 3B is a schematic drawing of in-flow liquid food processing using resistive heating according to prior art. With the illustrated process, the liquid food 22 is heated to its target sterilization or pasteurization temperature by ohmically heating the food itself. In some implementations, the path of the food product is divided into two sections: 24-1 and 24-2, which can be pipes. In operation, a pump 23 pumps liquid food 22 through the two serially arranged pipes 24-1 and 24-2. Each of the pipes (sections) is connected to a source of power 33-1, 33-2 providing electrical current to the food inside the pipes. For example, the electrodes of the sources of power 33-1, 33-2 may provide electrical current directly to the liquid food 22 inside the pipes 24-1, 24-2. Flanges 25 connect pipes 24-1, 24-2. The electrical current through the liquid food 22 ohmically heats the liquid food to its target temperature: The two sections 24-1 and 24-2 can be designed to achieve different temperature of the liquid food. Downstream of section 24-2 the temperature of the liquid food 22 may be brought down before the food leaves the processing unit. The outflowing pasteurized or sterilized food product can be collected under aseptic conditions into the food containers, and then sealed under aseptic conditions. However, maintenance of the aseptic conditions generally increases complexity and cost of the process.

Accordingly, food processing techniques that can heat up faster and/or within less demanding environment are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, an apparatus for heat treatment of food product by radio frequency (RF) includes: a transmission line having a center conductor that is a stack of food product packages. The apparatus also includes an outer shield having a metal pipe at least partially enclosing the center conductor; and an RF connector electrically coupled with the center conductor and with a source of RF voltage.

In one aspect, the outer shield is an electrically grounded metal pipe.

In one aspect, the apparatus further includes an inner shell disposed between the outer shell and the center conductor, where the RF voltage is at least partially conducted through the inner shell.

In another aspect, the apparatus of also includes a plurality of toroids disposed between the center conductor and the outer shield.

In one aspect, individual toroids are arranged uniformly along the center conductor. In another aspect, individual toroids are arranged non-uniformly along the center conductor.

In one aspect, a plurality of outer spacers electrically and mechanically separates the plurality of toroids from the outer shield. In another aspect, a plurality of inner spacers electrically and mechanically separates the plurality of toroids from the center conductor.

In one aspect, an end spacer terminates the center conductor, where the end spacer is electrically isolating, and where the end spacer is capacitive. In one aspect, the food product packages are food product cans.

In one aspect, a fluid cylinder element is configured to maintain an axial compressive force in the center conductor.

In one embodiment, an apparatus for heat treatment of food product by RF, includes: a center conductor configured for flowing a liquid food product through; an RF electrode in contact with the center conductor; an RF connector electrically coupled with the RF electrode; and an outer shield that at least partially surrounds the center conductor, wherein the outer shield is a grounded.

In one aspect, the RF electrode circumferentially surrounds the center conductor. In another aspect, the center conductor is a pipe having a food channel configured for flowing the liquid food product.

In one aspect, the apparatus also includes an impedance matching module coupled to the RF connector; and an RF generator coupled to the impedance matching module.

In one embodiment, a method for radio frequency (RF) heating of food product includes: arranging a stack of food product packages into a center conductor, where the center conductor is at least partially surrounded by an outer shield comprising a made of metal. The method also includes applying an RF signal to an RF connector that is electrically coupled with the center conductor; and heating the food product inside the stack of food product packages. In one aspect, the food product packages are food product cans.

In one aspect, the method also includes removing heated food product packages on one side of the stack; and adding fresh food product packages to the other side of the stack. In another aspect, the method of claim also includes spring-loading food product packages within the stack.

In one aspect, the RF signal is within a range of 3 MHz to 100 MHz.

In one aspect, the RF signal generates a standing wave that extends over at least 70% of a length of the stack of food product packages.

In one aspect, the stack of food product packages is mechanically separated from the outer shield by a plurality of toroids.

### DESCRIPTION OF THE DRAWINGS

The foregoing aspects and the attendant advantages of the present disclosure will become more readily appreciated as the same become better understood by reference to the following detailed description, when taken in conjunction with the accompanying drawings.

FIG. 1 is a block diagram of food product processing according to prior art;

FIG. 2 is a schematic drawing of steam heating of canned food product according to prior art;

FIG. 3A is a schematic drawing of liquid food processing using RF technology according to prior art;

FIG. 3B is a schematic drawing of in-flow liquid food processing using resistive heating according to prior art;

FIG. 4A is a partially schematic side view of canned food product processing unit using RF technology in accordance with an embodiment of the present technology;

FIG. 4B is a side view of the food processing shown in FIG. 4A;

FIGS. 5-5B show Detail A of FIG. 4A;

FIGS. 6 and 6A show Detail B of FIG. 4A;

FIG. 7 shows Detail C of FIG. 4A;

FIG. 8 is a partially exploded side view of a resilient loading in accordance with an embodiment of the present technology;

FIGS. 9A-9D are schematic drawings of several views of canned food product processing unit using RF technology in accordance with an embodiment of the present technology;

FIG. 9A is a partially schematic side view of canned food product processing unit using RF technology in accordance with an embodiment of the present technology;

FIG. 9B is a side view of the food processing shown in FIG. 9A;

FIG. 9C is an exploded view of a detail of FIG. 9A;

FIG. 9D is a cross-sectional view D-D of FIG. 9A;

FIG. 10A is a partially schematic side view of canned food product processing using RF technology in accordance with an embodiment of the present technology;

FIG. 10B is a side view of the food processing shown in FIG. 10A;

FIGS. 11A and 11B are schematic side views of continuous canned food product processing using RF technology in accordance with an embodiment of the present technology;

FIG. 12 is a flow diagram of canned food product processing in accordance with an embodiment of the present technology;

FIGS. 13A-13C are different views of liquid food processing using RF technology in accordance with embodiments of the present technology;

FIG. 14 is a flow diagram of liquid food processing in accordance with an embodiment of the present technology;

FIG. 15 is a schematic view of RF processing in accordance with an embodiment of the present technology; and

FIG. 16 is a schematic view of RF transmission line in accordance with an embodiment of the present technology.

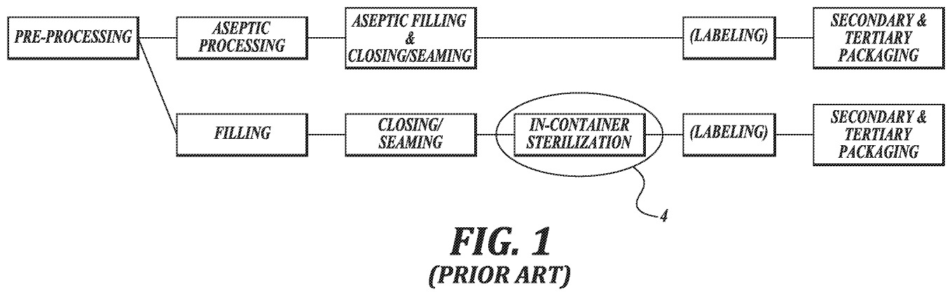

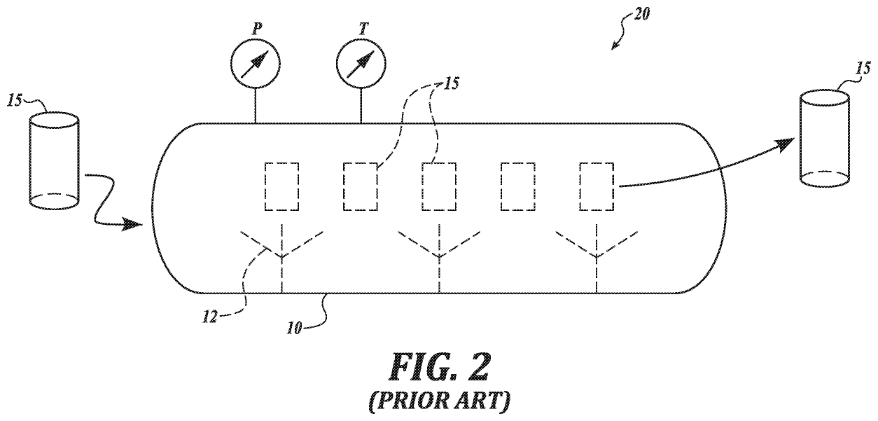

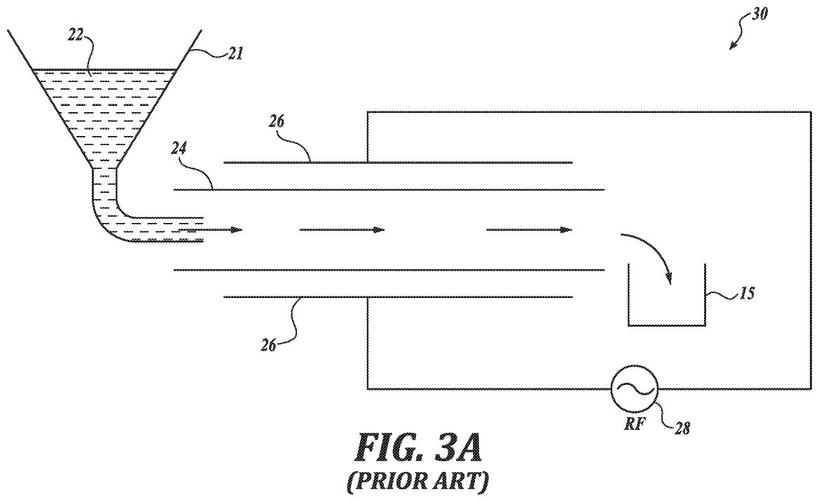

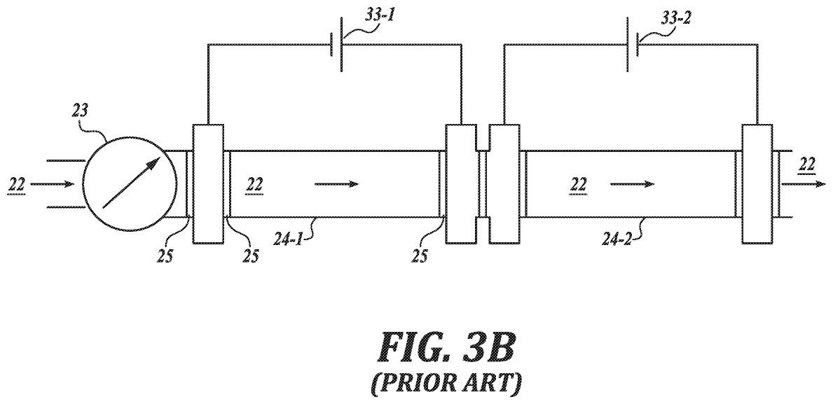

### DETAILED DESCRIPTION

Embodiments of apparatuses and methods related to radio frequency (RF) heating of food products. In some embodiments, cans of food product are arranged in a stack that is surrounded by an outer shell (e.g., a metal pipe). Such an arrangement may be viewed as a shielded conductor, a coaxial conductor or a transmission line, where the stack of canned food product is a center conductor (also referred to as inner conductor), while the outer shell is a shield. In the context of this disclosure, packaged food products are for simplicity and brevity referred to as canned food products. However, in different embodiments the packaged food products may include, for example, lidded jars (e.g., glass or plastic jars), boxes, sealed bags, and the like. In some embodiments, the lidded jars, boxes, etc., may include stackable metal endings and/or electrically conductive parts (e.g., metal elements) that connect these metal endings. In operation, a source of radio frequency (RF) is connected to the stack of canned food product, resulting in RF waves (e.g., a standing wave) along the stack of canned food product. Without being bound to theory, it is believed that peaks and valleys within the RF waves result in localized electrical currents that heat the cans and food product in the path of these electrical currents. In some embodiments, the food product inside the cans may heat faster than the can itself. Without being bound to theory, it is believed that such preferential heating of the food product is caused by the food product having a higher real component of resistance than that of the can itself. As a result, the resistive heating of the food product may be faster than the resistive heating of the can itself.

In some applications, this RF heating of the center conductor may reach the pasteurization or sterilization temperature of the food product inside the cans within several seconds or a sub-minute time, in contrast to the conventional heating methods that may require several minutes to reach the target temperature. Furthermore, and without being bound to theory, it is believed that RF heating of the inventive technology may be uniform enough to render unnecessary or at least to reduce the vibrations, rotations, shaking, etc., of the food product typically used in conjunction with the conventional technology.

In some embodiments, the RF signal operating point is selected to be below the resonant frequency of the load (i.e., the resonant frequency of the combination of the shielded conductor and termination). For example, the RF frequency may be about 27 MHz for the load having the resonant frequency of 40 MHz. Keeping the operating frequency below the resonant frequency results in an impedance matching design with a series inductor. Generally, designers of RF transmission lines are faced with a task of impedance matching in order to minimize energy losses along the transmission line. Contrary to this typical scenario in the RF engineering, in the inventive technology the energy losses are purposely maximized or at least increased by a controlled mismatch between the RF source impedance, the transmission line impedance, and the load impedance.

Within the stack of food product cans (or other food product packages), the top of one food product can makes electrical contact with a bottom of the next can by nesting. In some embodiments, electrical impedance among the cans may be at least partially controlled by applying an axial force along the stack of cans by, for example, a resilient element like a spring or a fluid (gas or hydraulic) cylinder.

In different embodiments, the center conductor may be terminated to ground through a resistor, to air (open termination), to ground through capacitor, to ground through inductor, or by a combination of the above. In general, different terminations may change the position and/or phase of the standing waves, therefore changing the distribution of the local voltages and currents, which, in turn, affect heating of the food product. For example, if the termination is capacitive the positions of the voltage/current standing waves are opposite to what they would be if the termination is an inductor. Therefore, instead of the high current being in the first part of the transmission line, such relatively high current would occur at the end of the transmission line.

In some embodiments, the center conductor (e.g., a stack of cans) may be separated from the outer shield by toroids that are electrically conductive rings. The toroids may be electrically isolated from the center conductor (the stack of cans) and the outer shield by isolating elements like, for example, Teflon spacers. In operation, presence of the toroids changes dielectric constant (k) of the space between the center conductor and the outer shield, inductance of the transmission line, and/or capacitance of the transmission line. In different embodiments, the toroids may be distributed uniformly or non-uniformly along the stack of canned food product. A non-uniform distribution of the toroids may change characteristic impedance along a portion of the transmission line, therefore localizing the voltage/current distribution at the target points along the center conductor. Such localization may be used to, for example, improve uniformity of heating.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

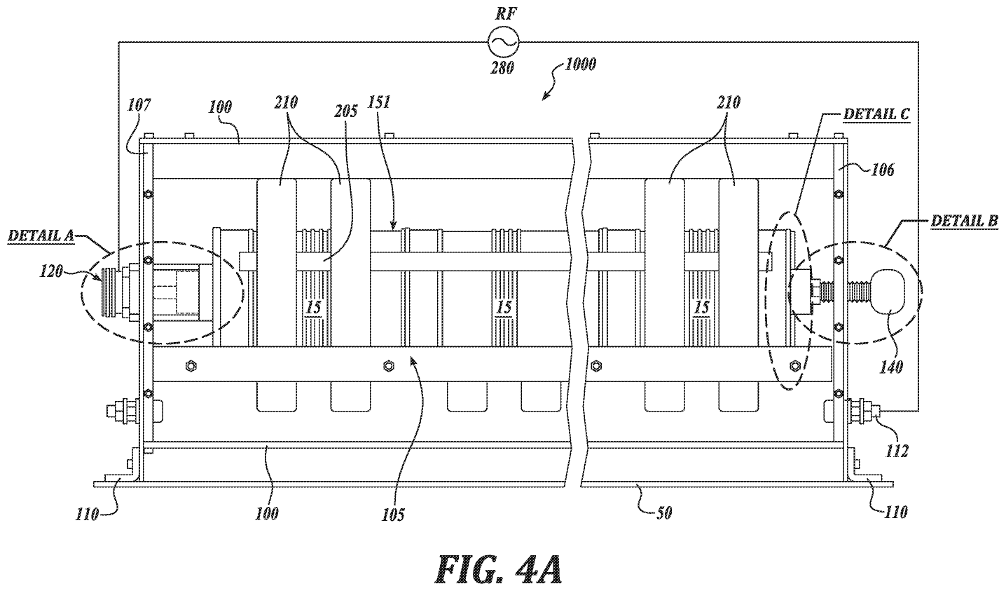

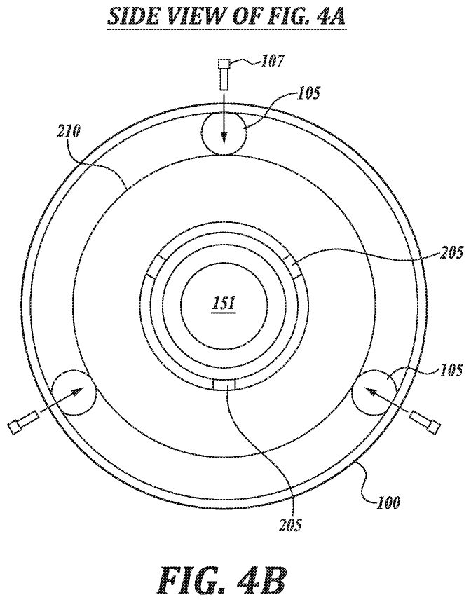

FIG. 4A is a partially schematic side view of canned food product processing unit using RF technology in accordance with an embodiment of the present technology. The illustrated unit 1000 has an inner conductor (center conductor) 151 that is formed of stacked food product cans 15. It should be understood that even though the disclosure refers to food product cans, other packaged food products are also encompassed by this disclosure. In different embodiments the packaged food products may include, for example, lidded jars (e.g., glass or plastic), boxes, sealed bags, and the like that may have stackable metal endings. In some embodiments, the lidded jars, boxes, etc., may include stackable metal endings and/or electrically conductive parts (e.g., metal elements) that connect these metal endings.

In operation, RF signal from an RF source 280 is fed to the center conductor 151 through an input connector 120 at one side of the center conductor. The opposite side of the center conductor 151 may terminate in a termination 140. Some examples of such termination are termination to ground through a resistor, to air (open termination), to ground through a capacitor, to ground through an inductor, or a combination thereof. The RF source 280 may terminate to ground through a ground connector 112. Some non-limiting examples of RF sources are power supplies that combine high frequency signal generators with power amplifiers.

The center conductor 151 may be at least partially surrounded by an outer shield (also referred to as an outer shell) 100. A nonlimiting example of such outer shield is a metal pipe. In some embodiments, the outer shield 100 may terminate to ground plane 50 through frame ends 106 and 107, and connecting feet 110.

In operation, RF signal from the RF source 280 may generate standing waves along the stack 151 of food product cans 15. The peaks and valleys of the RF waves cause localized electrical currents that heat the cans and food product inside the cans. In some embodiments, the heating of the food product is faster than the heating of the can itself, because of a higher real resistance of the food than is that of the metal can itself.

In some embodiments, frequency of the RF signal may be within 3 MHz to 100 MHz. In general, the operating frequency of the RF source 280 is different from the resonant frequency of the load. This impedance mismatch results in energy dissipation along the centerline conductor, i.e., along the stack of food product cans. The maximum power transfer theorem states that when the impedances between an RF source, the transmission line and the load are equal then maximum power is delivered to the load and there is no reflected power along the transmission line. With the inventive technology the designed mismatch between the source, the transmission line and the load termination, standing waves are formed along the length of the transmission line. Theoretically, when the impedances between an RF source and the load perfectly match, the reflected power along the transmission line is zero, and therefore power dissipation in the transmission line is also zero. Such theoretical perfect match may be also expressed as a match between the load impedance (e.g., the transmission line plus the termination) and the impedance of the RF source. With the inventive technology, because of the designed mismatch between the load impedance and the source impedance, standing waves are formed along the length of the of the transmission line (e.g., a stack of food product cans), resulting in the heating of the transmission line. In some embodiments, the heating may correspond to 90% or more of the energy provided by the RF source.

Without being bound to theory, it is believed that a standing wave (also referred to as a power standing wave) develops along the length of the transmission line (e.g., a stack of food product cans or other packages). In general, curve of temperature along the centerline correlates with the shape of such power standing wave. It is believed that the power standing wave is characterized by a power factor that varies along the transmission line, and that the heating of the centerline (and, consequently, temperature of the centerline) varies along the curve that describes the power factor. For example, the power dissipated along the centerline conductor may be expressed as a product of local voltage and current, multiplied by a cosine of the phase angle between the local voltage and current along the transmission line. Therefore, in at least some embodiments, the system may be designed to have about a quarter wave length along the entire length or along the major part of the length of the centerline stack, therefore promoting heating of the most of the middle portion of the center conductor.

In some embodiments, the stack (center conductor) 151 is separated from the outer shield 100 by one or more toroids 210 that may be made of metal (e.g., ferromagnetic steel, nickel alloys, cobalt alloys, etc.) or other materials. Presence of the toroids 210 changes a dielectric constant (k) in the space between the center conductor 151 and the outer shield 100; inductance (L) of the transmission line; and/or capacitance (C) of the transmission line. In some embodiments, this change in properties may be useful for controlling the mismatch between the resonant frequency of the load (e.g., combination of transmission line and termination) and the frequency of the RF source.

In the illustrated embodiment, the toroids 210 are distributed non-uniformly along the center conductor 151, therefore non-uniformly localizing the voltage/current distribution at the target points along the center conductor. Such localization may be used to, for example, improve heating of the canned food product at the periphery of the stack 151. In other embodiments, the toroids may be distributed uniformly along the stack of canned food product (center conductor) 151. The toroids 210 may be separated from the stack 151 and/or the outer shield 100 by electrically insulating spacers, as explained in more detail below with reference to FIG. 4B.

FIG. 4B is a side view of the food processing shown in FIG. 4A. In some embodiments, the toroids 210 are disposed between the outer shell 100 and the center conductor that is a stack 151 of food product cans 15. The toroids 210 may be electrically insulated from the outer shell 100 by outer spacers 105, which may be made of Teflon or other electrically isolating material. The outer spacers 105 may be held in place by the corresponding fasteners 107. On their inner side, the toroids 210 may be kept apart from the stack 151 by inner spacers 205 that are also made of the electrically isolating material, for example Teflon. In some embodiments, the outer spacers 105 and/or the inner spacers 205 may extend along the stack 151.

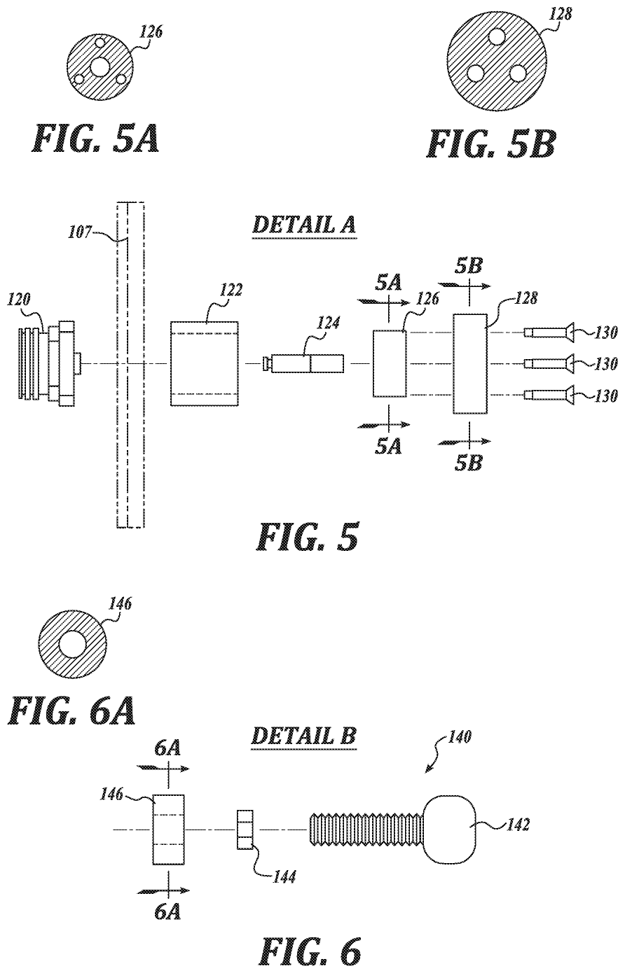

FIGS. 5-5B show Detail A of FIG. 4A. FIG. 5 shows a side exploded view of the RF input connector 120 and its electrical connection to the inner conductor 151. The RF connector 120 may be electrically isolated from the frame end 107 by a tube spacer 122 that may be made of Teflon or other electrically isolating material, or other means such as Teflon washers. The incoming RF signal is next transferred through a connector pin 124 to a set of pins 130, and further to the center conductor 151. FIGS. 5A and 5B illustrate cross-sections of the connector plates 126 and 128, respectively. The connector plates 126 and 128 align and house the connector pin 124 and pins 130. In other embodiments, different designs may be used for the RF input connector and other parts that connect the RF source 280 with the inner conductor 151.

FIGS. 6 and 6A show Detail B of FIG. 4A. FIG. 6 shows the side exploded view of the RF ground connector 140. In some embodiments, the RF ground connector 140 may simply terminate into air. The illustrated RF ground connector 140 includes a sample thumb screw 142, a fastener 144 (e.g., a nut) and a plate (e.g., copper plate) 146. FIG. 6A shows a sample cross-section of the plate 146. In other embodiments, the RF ground connector 140 may terminate into a capacitive, an inductive or ground termination.

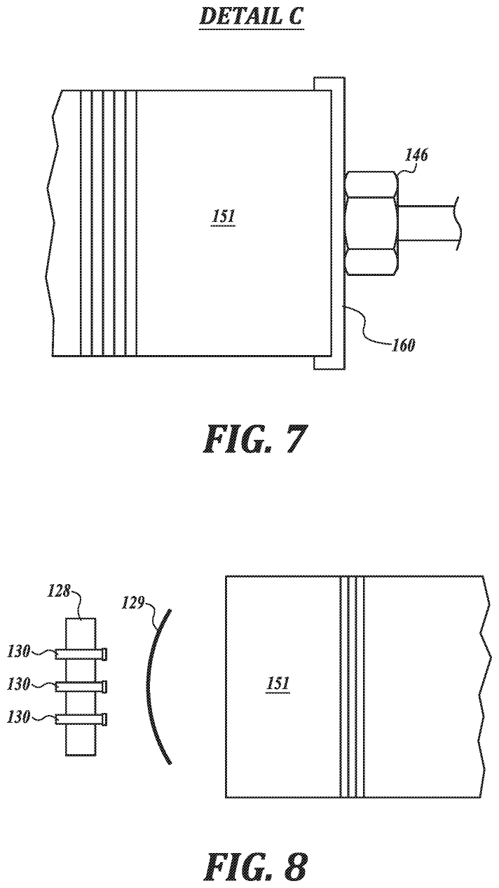

FIG. 7 shows Detail C of FIG. 4A. In the illustrated embodiment, the stack of food product cans (or other food product packages) 151 is separated from the plate 146 by an end spacer 160. The illustrated end spacer 160 is a Teflon capacitor, creating a predominantly capacitive termination at the end of the stack of food product cans 151. In some embodiments, the capacitance of the end spacer 160 may be about 20 pf. In a sample practical implementation, the Teflon capacitor may be a thin disc between the last can in the stack of food product cans and the ground. In some embodiments, the capacitive termination may increase a span of the standing RF wave to about 70% of the length of the stack or more for the RF frequency of about 27 MHz.

FIG. 8 is a partially exploded side view of a resilient loading in accordance with an embodiment of the present technology. In some embodiments, a resilient structure 129 may be inserted between the connector plate 128 and the first can in the stack of food product cans 151. A non-limiting example of such resilient structure 129 may be a coil spring or a plate spring. In operation, the resilient structure 129 generates axial force along the stack of food product cans 151 to maintain a relatively stable axial compression along the stack. In some embodiments, such relatively stable compression results in a better control of the impedance of the stack (center conductor) 151, in turn promoting a relatively stable standing wave along the span of the stack of food product cans 151.

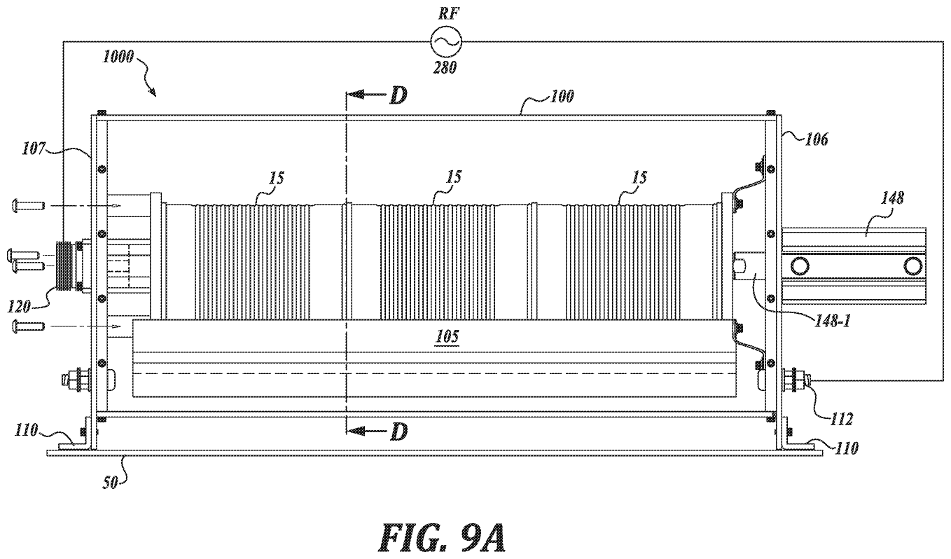

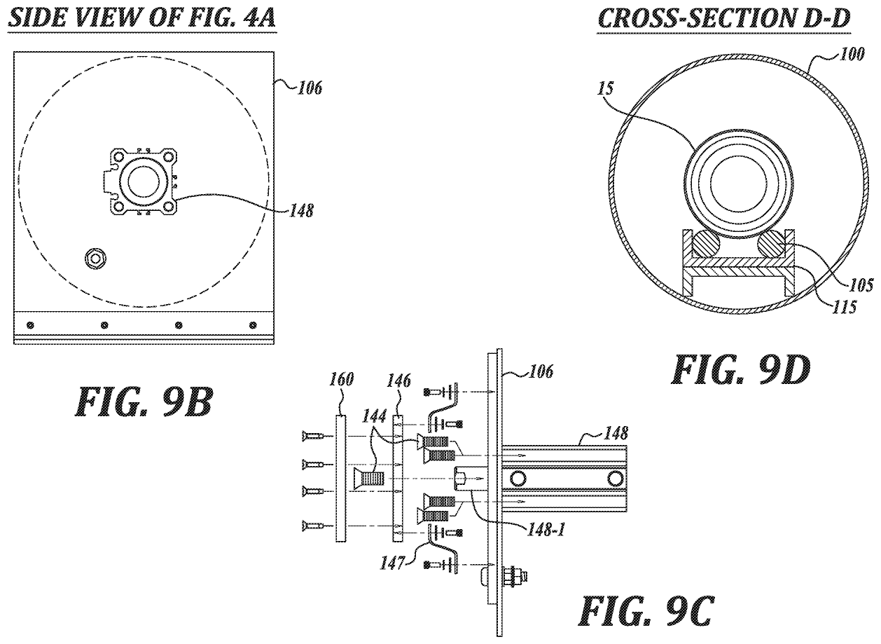

FIGS. 9A-9D are drawings of several views of canned food product processing unit using RF technology in accordance with an embodiment of the present technology. In the side view of FIG. 9A, three food packages 15 are illustrated, but a person of ordinary skill would understand that in different embodiments different numbers of food packages may be used to form a center conductor.

The embodiments illustrated in FIGS. 9A-9D operate in a generally analogous manner as do those illustrated in FIGS. 4A-8. However, in the embodiments of FIGS. 9A-9D, axial force along the stack of food product cans 15 is generated by an air cylinder or a hydraulic cylinder 148 (collectively, a fluid cylinder). In operation, a piston 148-1 produces a relatively stable axial compression along the stack food product cans 15. As described above, in some embodiments, such relatively stable compression results in a better control of the impedance of the stack (center conductor) 151, which in turn promotes a relatively stable standing wave along the span of the stack of food product cans. Furthermore, the axial force in the centerline conductor is controllable by changing the pressure of gas or liquid inside the pressure cylinder 148. Without being bound to theory, it is believed that the axial force influences (at least) the real component of the impedance of the stack of food product cans, thus providing another control mechanism for achieving a target impedance of the stack.

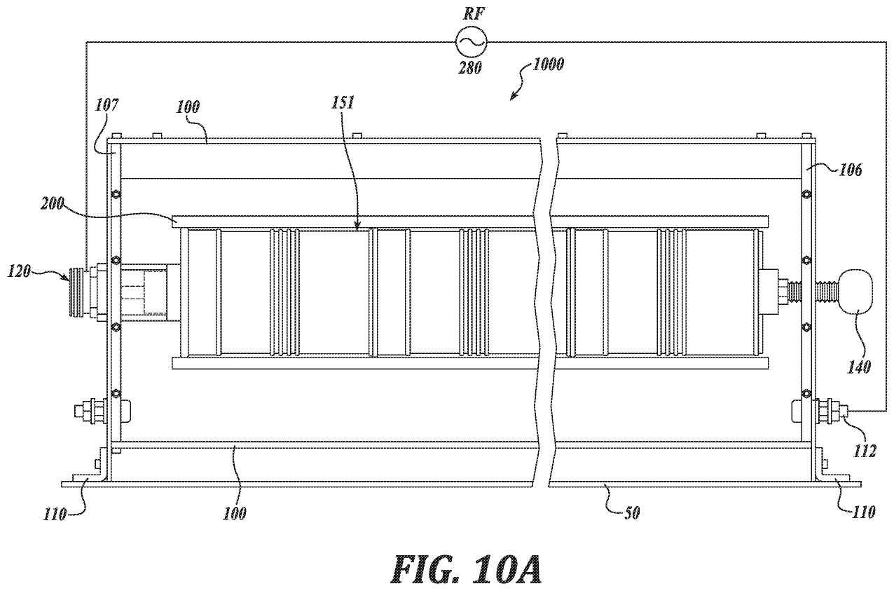

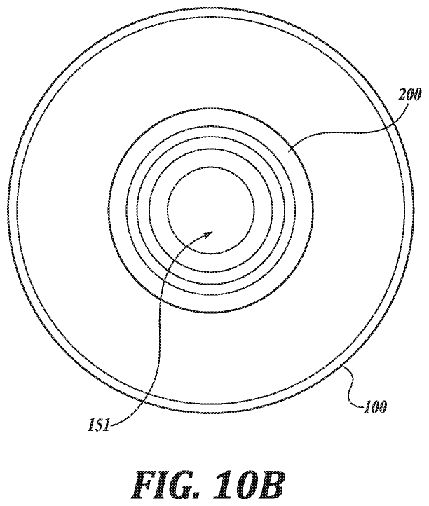

FIG. 10A is a partially schematic side view of canned food product processing using RF technology in accordance with an embodiment of the present technology. In the illustrated embodiment, the stack of food product cans 151 is enclosed within an inner shell 200, which may be a pipe (e.g., a metal pipe). The electromagnetic properties of the inner shell 200 at least partially determine the impedance of the combination of the stack of food product cans 151 and the inner shell 200. For example, the inner shell 200 may decrease the real resistance of the path of the RF waves, because of the relatively low electrical resistance of the inner shell 200. Furthermore, the inner shell 200 may also affect the capacitance and impedance of the RF path. In different embodiments, the inner shell 200 may be used with or without the toroids 210.

FIG. 10B is a side view of the food processing unit shown in FIG. 10A. In different embodiments, the inner shell 200 may contact or be spaced apart from the stack of food product cans 151. Collectively, the inner shell 200 and the stack of food product cans 151 may be understood as a center conductor.

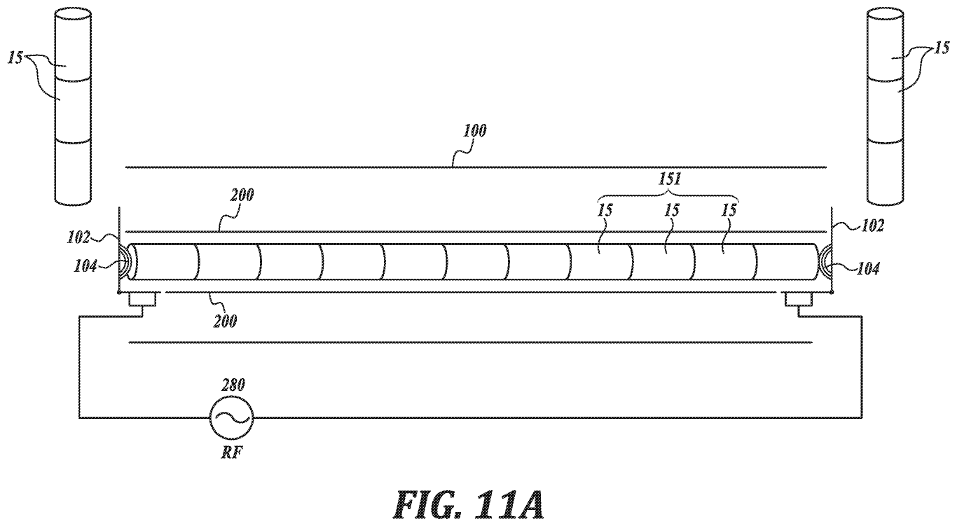

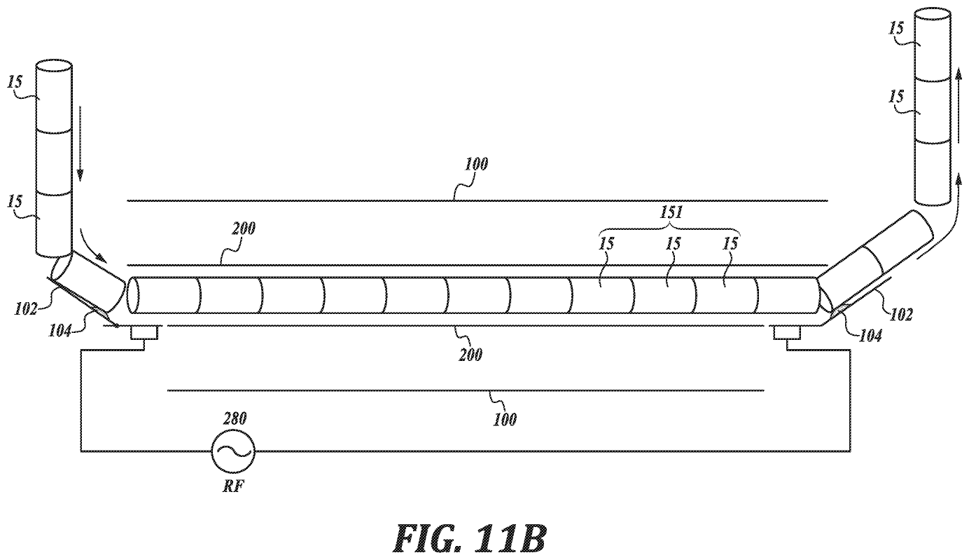

FIGS. 11A and 11B are schematic side views of continuous canned food product processing using RF technology in accordance with an embodiment of the present technology. The stack of food product cans (or other food product packages) 151 may be axially compressed between the resilient structures 104 at the two ends of the stack. In operation, the RF source 280 provides RF signal to the stack 151 for a duration of time that results in reaching the pasteurization or sterilization temperature of the food product, or any other target temperature, as described with reference to FIGS. 4A-10B above. After the food product achieved its target temperature, the food cans 15 may be partially or completely replaced as explained with reference to FIG. 11B below.

FIG. 11B is a schematic drawing that illustrates replacement of individual food cans 15. In some embodiments, several food cans 15 may be removed at one end of the stack 151 after the food product in those cans achieves the target temperature. Concurrently, several new food cans 15 may be added at the other side of the stack 151 by opening a plate 102. Next, the plates 102 at the two ends of the stack 151 may be closed to establish electrical contact and/or axial compression along the stack 151, followed by the application of the RF signal from the RF source 280 to continue the heating process of the cans 15. After a prescribed duration of time or after the target temperature of the food product is reached, one or more food cans 15 at one end of the stack 151 are removed, fresh cans 15 are added to the stack 151, and the process repeats. It will be understood that different can replacement mechanisms (e.g., mechanical, pneumatic, solenoid servo, etc.) may be used and are encompassed in this disclosure.

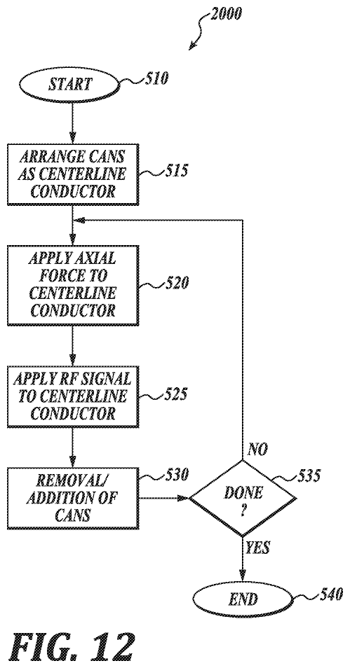

FIG. 12 is a flow diagram of canned food product processing in accordance with an embodiment of the present technology. In some embodiments, the process may include only some of the blocks of a schematic diagram 2000, or may include additional steps that are not illustrated in the schematic diagram 2000. The process starts in block 510, and proceeds to block 515 where cans are arranged into a centerline conductor 151. In some embodiments, this centerline conductor 151 is at least partially surrounded by an outer shell 100. In block 520, axial force is applied to the centerline conductor 151. This axial force may be applied through resilient elements, pneumatic cylinders, electrical solenoids, and the like.

In block 525, RF signal is applied to the centerline conductor 151. The RF signal may be produced by the RF source 280. When subjected to an RF wave, a mismatch between the impedance of the centerline conductor 151 and that of the RF source 280 will cause heat dissipation along the centerline conductor 151. Stated differently, the centerline conductor 151 (e.g., a stack of cans 15) becomes the load of the RF circuit. In operation, standing RF waves along the centerline conductor 151 heat up the food product inside cans. After the food product reaches the target temperature, in block 530 some of the heated cans may be removed and replaced by the fresh cans for further processing. In block 535, a determination is made whether the process is completed. If further cans 15 need to be thermally treated, the process goes back to block 520. Otherwise, if the prescribed number of food product cans are already thermally treated, the process ends in block 540.

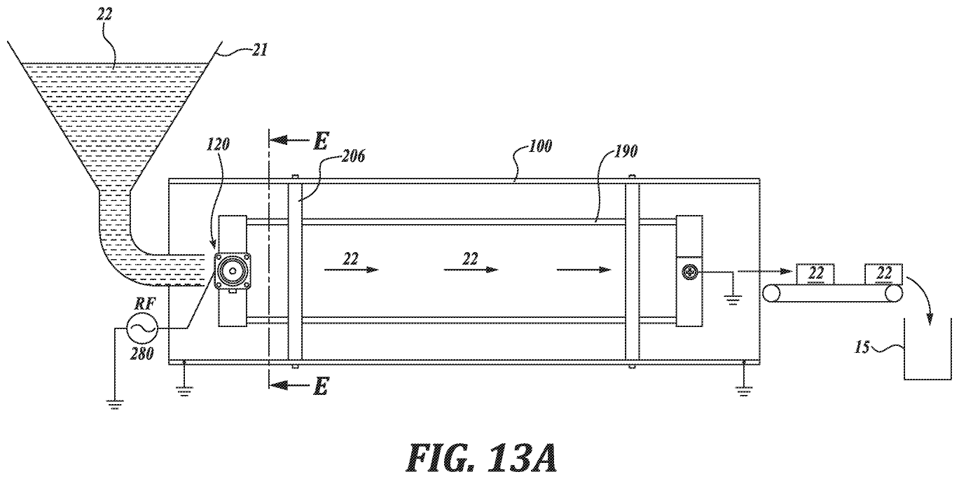

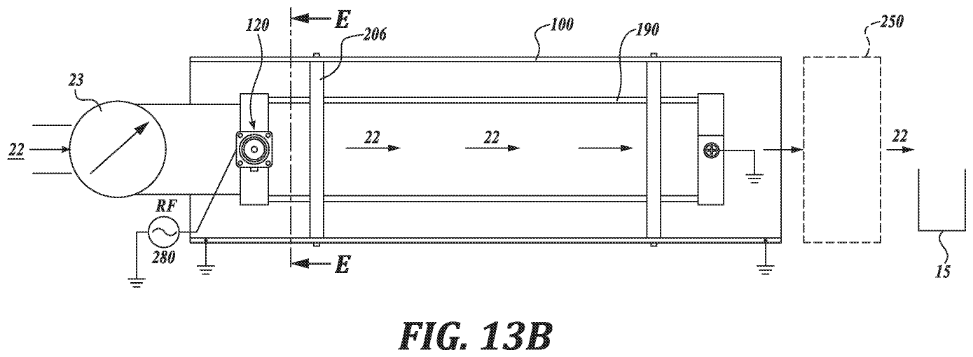

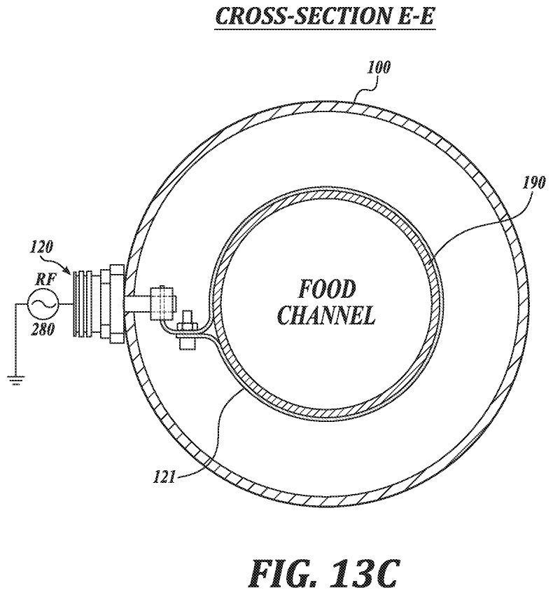

FIGS. 13A-13C are different views of liquid food processing using RF technology in accordance with embodiments of the present technology. FIG. 13A is a side view of liquid food processing using RF technology in accordance with an embodiment of the present technology. In some embodiments, the liquid food 22 may be preheated (e.g., using a steam heating) to about 90° C. before starting the RF heating process. In the illustrated embodiment, the RF source 280 is connected to one side of a food channel 190 (also referred to an inner pipe), while the other side of the food channel 190 is grounded. The food channel 190 may be at least partially enclosed by the outer shell 100. An inner support element 206 may maintain a prescribed spacing between the outer shell 100 and the food channel 190. The inner support element 206 may be made of Teflon or other electrically isolating material.

In operation, food product (e.g., liquid food) 22 is pumped or gravity-fed through the food channel 190. Because of the mismatch between the impedance of combined food channel and the food flowing through it versus the impedance of the RF generator 280, standing waves form along the food channel 190, dissipating the RF energy through resistive heating. As a result, the liquid food product heats up as it flows through the food channel 190, achieving its target temperature and time for cooking before exiting the food channel 190. Such cooked food 22 at the exit of the food channel 190 may be sliced and packed for cold storage and handling.

FIG. 13B is a side view of liquid food processing using RF technology in accordance with an embodiment of the present technology. The illustrated embodiment is similar to the embodiment shown in FIG. 13A. However, the liquid food product 22 that heats up as it flows through the food channel 190 remains in a liquid form when exiting the food channel 190. For example, the liquid food 22 may exit the food channel 190 at about 120° C. and enter a heat exchanger 250, where the temperature of the liquid food is reduced to about 80° before being packaged in the package 15.

FIG. 13C is a cross-sectional view E-E of the liquid food processing shown in FIGS. 13A and 13B. In some embodiments, the food channel 190 (e.g., a metal pipe) is at least partially surrounded by an RF electrode 121 that is connected to an RF input connector 120. A similar electrode (not shown) may connect the other and of the food channel 190 to ground or other termination (e.g., capacitive, inductive, resistive, or a combination thereof). In operation, the RF signal passes from the RF input connector 120, to the RF electrode 121, through the food channel 190 and liquid food 22, and to the ground.

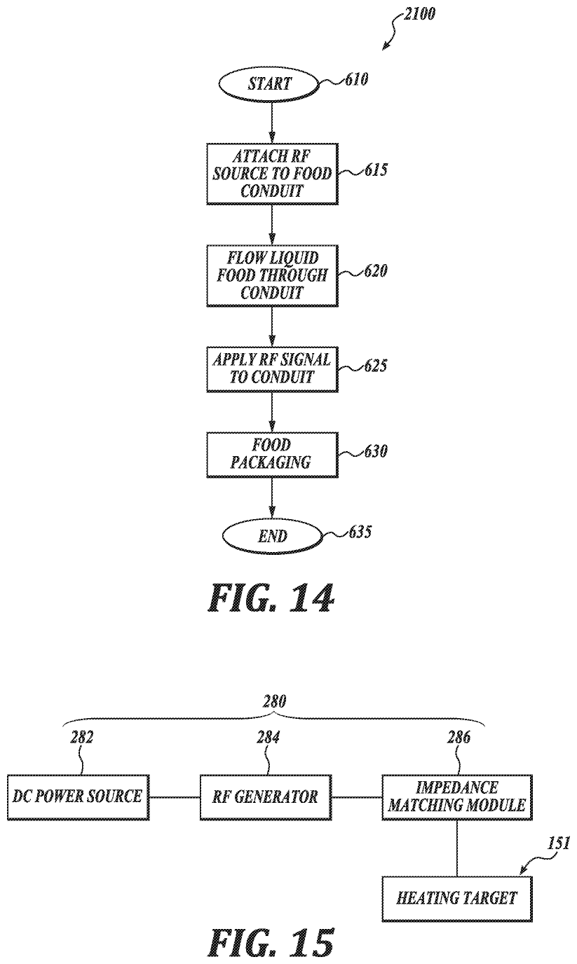

FIG. 14 is a flow diagram of liquid food processing in accordance with an embodiment of the present technology. In some embodiments, the process may include only some of the blocks of a schematic diagram 2100, or may include additional steps that are not illustrated in the schematic diagram 2100. The process starts in block 610, and proceeds to block 615 where an RF source is attached to the food conduit (channel) 190. In block 620, liquid food starts flowing through the food channel 190. In block 625, RF signal is applied to the food channel 190. In response, the food product inside the food channel 190 heats up and is being cooked as it further pushed through the food channel. As explained above, heating of the food product depends at least in part on the impedance mismatch between the combination of the food channel and grow food on one side, and the impedance of the RF source on the other side. In different embodiments, process may be designed to heat the liquid food product to its respective cooking temperature.

In block 630, the food product is packaged. The process may end in block 635.

FIG. 15 is a schematic view of RF processing in accordance with an embodiment of the present technology. In some embodiments, the RF source 280 may include a DC power source 282, an RF generator 284, and an impedance matching module 286. In some embodiments, the impedance matching module 286 may adjust the impedance of the RF source 280 to differ from the impedance of a heating target 151 (e.g., a stack of canned food product or liquid food in a food channel). As a result, the energy of RF signal is dissipated as heat due to heating of the centerline conductor (e.g., a stack of canned food product or liquid food in a food channel). In different embodiments, the impedance matching module 286 may produce a variable or a constant impedance.

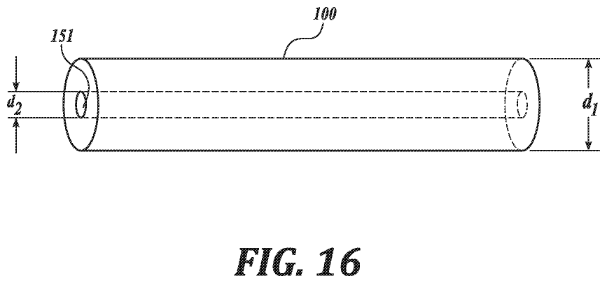

FIG. 16 is a schematic view of RF transmission line in accordance with an embodiment of the present technology. In general, the RF transmission line includes centerline conductor 151 and an outer shield 100. It can be shown that the characteristic impedance of the illustrated transmission line corresponds to:

$${Z}_{0} = \frac{138}{\sqrt{k}} log \frac{{d}_{1}}{{d}_{2}}$$

where Z₀ is a characteristic impedance of the transmission line, d₁ is the inside diameter of outer conductor (outer shield 100), d₂ is an outside one of the inner conductor 151, and k is the relative permittivity of insulation between the conductors. In some embodiments, a relatively low-impedance line may be characterized by the following values:

Z₀=6.37 ohms

d₁=86 mm (aluminum tube)

d₂=74 mm (cans)

k=2 (Teflon)

In other embodiments, a relatively high-impedance line may be characterized by:

Z₀=36 ohms

d₁=135 mm

d₂=74 mm

k=1 (air)

The inductance for low-impedance line may be about 0.03 uh/meter, whereas capacitance for low-impedance line may be about 521 pf/meter. Conversely, inductance for high-impedance line may be about 0.12 uh/meter, whereas capacitance for high-impedance line may be about 92 pf/meter. In the above examples, the system includes a coaxial transmission line terminated by a connection to ground.

The system 1000 illustrated in FIGS. 10A-12A may be modeled as a coaxial transmission line terminated into an impedance other than its characteristic impedance. The RF frequencies may range, for example, from 13 to 100 MHz. The dissipated power may exceed 1,000 W or several kW. In some embodiments, the system may be optimized to produce peak voltages at the top of every other can. Without being bound to theory, it is estimated that for the RF frequency of 27 MHz, the actual wavelength of the standing wave in the stack of cans 151 is about 7 meters compared to about 11 meters in free space. The shortening of the wavelength in the center conductor is believed to be caused by the loss of the center conductor 151.

Many embodiments of the technology described above may take the form of computer-executable or controller-executable instructions, including routines executed by a programmable computer or controller. Those skilled in the relevant art will appreciate that the technology can be practiced on computer/controller systems other than those shown and described above. The technology can be embodied in a special-purpose computer, application specific integrated circuit (ASIC), controller or data processor that is specifically programmed, configured or constructed to perform one or more of the computer-executable instructions described above. Of course, any logic or algorithm described herein can be implemented in software or hardware, or a combination of software and hardware.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is intended that embodiments described herein be limited only by the claims.

1. An apparatus for heating food product by radio frequency (RF), the apparatus comprising:
a transmission line comprising:
a center conductor comprising at least one food product package, and
an outer shield at least partially enclosing the center conductor; and
an RF connector electrically coupled with the center conductor and with a source of RF energy.

2. The apparatus of claim 1, wherein the outer shield is an electrically grounded metal pipe.

3. The apparatus of claim 1, further comprising an inner shell disposed between the outer shield and the center conductor, wherein the RF energy is at least partially conducted through the inner shell.

4. The apparatus of claim 1, further comprising a plurality of toroids disposed between the center conductor and the outer shield.

5. The apparatus of claim 4, wherein individual toroids are arranged uniformly along the center conductor.

6. The apparatus of claim 4, wherein individual toroids are arranged non-uniformly along the center conductor.

7. The apparatus of claim 4, further comprising:
a plurality of outer spacers that electrically and mechanically separates the plurality of toroids from the outer shield, and a plurality of inner spacers that electrically and mechanically separates the plurality of toroids from the center conductor.

8. The apparatus of claim 4, wherein the at least one food product package comprises a plurality of food product cans.

9. The apparatus of claim 1, further comprising:
an end spacer that terminates the center conductor, wherein the end spacer is electrically isolating, and wherein the end spacer is capacitive.

10. The apparatus of claim 1, further comprising:
a compressive element configured to maintain an axial compressive force in the center conductor.

11. An apparatus for heating food product by radio frequency (RF), comprising:
a center conductor configured for flowing a liquid food product through;
an RF electrode electrically coupled with the center conductor;
an RF connector electrically coupled with the RF electrode; and
an outer shield that at least partially surrounds the center conductor, wherein the outer shield is grounded.

12. The apparatus of claim 11, wherein the RF electrode circumferentially surrounds the center conductor.

13. The apparatus of claim 11, wherein the center conductor is a pipe having a food channel configured for flowing the liquid food product.

14. The apparatus of claim 11, further comprising:
an impedance matching module coupled to the RF connector; and
an RF generator coupled to the impedance matching module.

15. A method for radio frequency (RF) heating of food product, comprising:
arranging at least one food product package into a center conductor, wherein the center conductor is at least partially surrounded by an outer shield;
applying an RF signal to an RF connector that is electrically coupled with the center conductor; and
heating the food product inside the at least one food product package.

16. The method of claim 15, wherein the at least one food product package comprises a plurality of food product packages in a stack, the method further comprising:
removing heated food product packages on one side of the stack; and
adding new food product packages to the other side of the stack.

17. The method of claim 15, wherein the at least one food product package comprises a plurality of food product packages in a stack, the method further comprising:
axially compressing the food product packages within the stack.

18. The method of claim 15, wherein the RF signal is within a range of 3 MHz to 100 MHz.

19. The method of claim 17, wherein the RF signal generates a standing wave that extends over at least 70% of a length of the stack of food product packages.

20. The method of claim 15, wherein the at least one food product package is mechanically separated from the outer shield by a plurality of toroids.

21. The method of claim 15, wherein the at least one food product package is a food product can.

22. The apparatus of claim 10, wherein the compressive element is selected from a group consisting of a hydraulic cylinder, a gas cylinder, a resilient structure, a screw, and an electrical solenoid.

23. The method of claim 17, wherein axially compressing food product packages within the stack is performed by a compressive element selected from a group consisting of a hydraulic cylinder, a gas cylinder, a resilient structure, a screw, and an electrical solenoid.
